(19) United States
(12) Patent Application Publication
(10) Pub. No.: US 2018/0349336 A1
(43) Pub. Date: Dec. 6, 2018

(54) Method for Producing a College Application Essay

(71) Applicant: Mitchell German, Lincroft, NJ (US)

(72) Inventor: Mitchell German, Lincroft, NJ (US)

(21) Appl. No.: 16/001,607

(22) Filed: Jun. 6, 2018

Related U.S. Application Data
(60) Provisional application No. 62/515,871, filed on Jun. 6, 2017.

(51) Int. Cl. G06F 17/24; G09B 5/02; G06F 3/0482; G06F 3/0483

(52) U.S. Cl. CPC G06F 17/241; G06F 17/243; G06F 3/0483; G06F 3/0482; G09B 5/02

(57) ABSTRACT

An interactive method for drafting a college admissions essay includes a series of instructional videos for creating an engaging essay based on universal story telling principles and employing an application program providing a structured series of opportunities for the student participant to input relevant text.

### CROSS REFERENCE TO RELATED APPLICATION

This application claims the benefit of the priority of U.S. Provisional Application No. 62/515,871, filed Jun. 6, 2017, which is incorporated by reference herein in its entirety.

### BACKGROUND OF THE INVENTION

### 1. Field of the Invention

The present invention relates to an interactive, structured, method for generating a college application essay.

### 2. Brief Description of the Prior Art

Among the criteria which many institutes of higher learning employ to evaluate candidates for admission is the personal essay. English composition is an important skill for success in higher education, and a well-written, engaging essay puts an applicant's skill in this endeavor on display, and offers an opportunity to distinguish him or herself from other candidates.

Computer-based essay writing systems are known. For example, U.S. Pat. No. 8,688,026 discloses an essay writing system for teaching exspository writing to students in which students are prompted to provide input for a thesis statement, a topic sentence, and a conclusion sentence, and the system generates a color-coded draft essay. More generally, U.S. Patent Publication 2017/0017630 discloses a document preparation platform which can be used to generate a college application essay. Similarly, U.S. Patent Publication 2004/0250209 discloses an automated composition assistant for guiding an author through the steps of creating, reviewing, an correcting a coherent and organized composition.

There is a continuing need for assistance in essay composition in general, and for assistance in composing college admission essays for students.

### SUMMARY OF THE INVENTION

The present invention provides a method for producing a college admission essay carried out by a participant using a computer system and at least one application program. The computer system includes a display, at least one processor, input means, a data storage means. The method of present invention includes providing on the display a first control ribbon including a plurality of controls permitting the participant to control the application program, the plurality of controls including a dashboard control for accessing a plurality of instructional videos, each video being directed to an explanation of a corresponding drafting step in the process for developing a college admissions essay.

The method of the present invention also provides on the first control ribbon a first sentence drafting control (Four Sentences). When selected the first sentence drafting control displays on the display a plurality of text input windows or a first plurality of title bubbles, which correspond to and can be used to display the plurality to text input windows. The participant then preferably enters text in the text input windows.

The method of the present invention also presents on the first control ribbon a second sentence drafting control (Essay). When selected the second sentence drafting control provides a plurality of title bubbles on the display for the participant. The title bubbles are preferably arranged in a predefined order corresponding to the drafting steps in the process for developing a college admissions essay. This second plurality of title bubbles preferably also includes the first plurality of title bubbles.

In the method of the present invention, the participant preferably activates at least one of the title bubbles to provide a note bubble, the note bubble being related to the corresponding title bubble. The participant then preferably enters text in the note bubble. Preferably, the participant activates each of the title bubbles to provide corresponding note bubbles, and the participate preferably enters text in each of the note bubbles.

Preferably, the method of the present invention comprises including the text previously entered by the participant in the text input windows in the at least one of the note bubbles. Preferably, the text in each of the text input windows is entered in a corresponding note bubble. Preferably, the text from each of the text input windows automatically populates the corresponding note bubble when the note bubble is first activated.

Preferably, the method of the present invention includes providing on the display a second control ribbon. Preferably, the second control ribbon includes a control for a menu of text controls relating to the text entered by the participant. Preferably, the menu of text controls includes at least a text merge control for merging the text entered by the participant in the predefined order provided by the title bubbles provided by the second sentence drafting control into a document.

Preferably, the method of the present invention wherein the plurality of instructional videos includes a first instructional video, the first instructional video providing instruction for entering text in the plurality of text input windows.

Preferably, the text entered in the plurality of text windows populates a corresponding plurality of note bubbles.

Preferably, the plurality of instructional videos includes at least one video providing instructions for entering text in at least one note bubble. More preferably, the plurality of instructional videos provide instructions for entering text in each of the note bubbles.

Preferably, the text merge control opens an initial text processor window and displays the merged text in the text processor as a draft of the college application essay for further development by the participant.

Preferably, the menu of text controls includes a control for duplicating the text in the initial text processor window in a successive text processor window. More preferably, the menu of text controls include controls for duplicating text from a earlier text processor window in subsequent text processor window.

Preferably, each title bubble includes a text field and an actions field.

Preferably, the actions field of the title bubble includes at least a control for creating a related note bubble.

Preferably, each note bubble includes a text field in which the participant can enter text and an actions field including controls.

Preferably, each title bubble includes a help control for displaying a help window with instructional text specific to each title bubble.

Preferably, each title bubble includes a new title bubble control for generating a new title bubble.

Preferably, the actions field of each note bubble includes a history display control for displaying a history window showing the history of text entered into the note bubble.

Preferably, the actions field of each note bubble includes a new note bubble control for generating a new note bubble linked to the note bubble.

Preferably, the actions field of each note bubble includes a subnote bubble control for generating a subnote bubble linked to the note bubble.

Preferably, the subnote bubble includes a field for entering text and a control for displaying the history of text entered into the subnote bubble text field.

Preferably, the text merge control merges all the text in each note bubble, each linked note bubble, and each linked subnote bubble corresponding to each title bubble into the text processor window in the predefined order.

Preferably, each subnote bubble is merged under each linked not bubble and each note bubble is merged under its immediately preceding linked note bubble or linked title bubble as the case may be.

Preferably, the actions field includes an attachments control for adding a preexisting file to the document.

Preferably, the application program is hosted on a cloud-based server and provided to the participant on an internet-enabled access device.

Preferably, the method includes a progress window for displaying to the participant the participant's completion of the drafting steps.

Preferably, the method includes a share control for generating a share window for entering information to identify other individuals with whom the participant desires to share the participant's text entered using the method and a control for sharing the text.

Preferably, the method further provides in the share control a comments control for permitting the other individuals to comment on the shared text.

### BRIEF DESCRIPTION OF THE DRAWINGS

FIG. 1 is a schematic view of an apparatus or computer system for carry out the method of the present invention.

FIG. 2 is a schematic view of a display showing a first screen shot created by the method of the present invention.

FIG. 3 is a schematic view of a display showing a second screen shot created by the method of the present invention.

FIG. 4 is a schematic view of a display showing a third screen shot created by the method of the present invention.

FIG. 5 is a schematic view of a display showing a fourth screen shot created by the method of the present invention.

FIG. 6 is a schematic view of a display showing a fifth screen shot created by the method of the present invention.

FIG. 7 is a schematic view of a display showing a sixth screen shot created by the method of the present invention.

FIG. 8. is a schematic representation of a menu created by the method of the present invention.

FIG. 9 is a schematic view of a display showing a seventh screen shot created by the method of the present invention.

### DETAILED DESCRIPTION

The present invention provides an interactive method for producing a college admission essay carried out by a participant using a computer system and at least one application program.

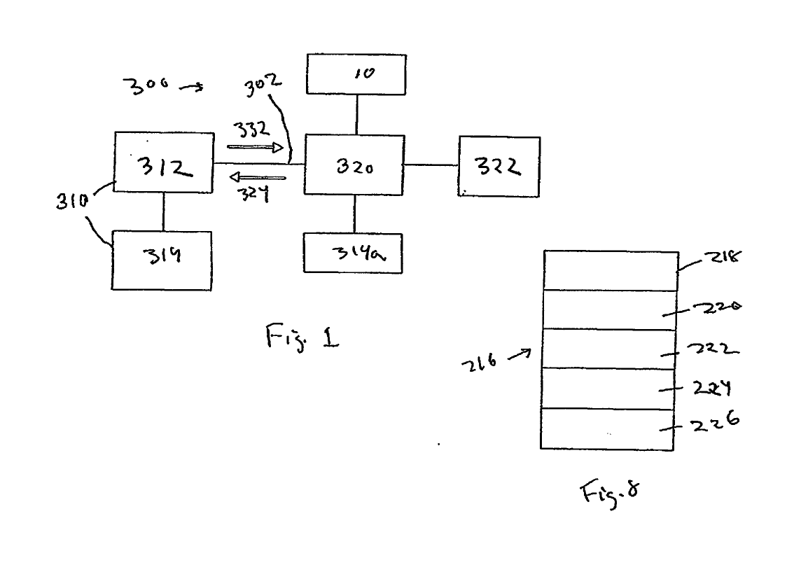

Referring now to the figures in which like reference numerals represent like elements in each of the several views, there is shown in FIG. 1, a schematic view of an apparatus or computer system 300 for carrying out the method of the present invention. The computer system 300 preferably includes a display 10, at least one processor 312, input means 322, and a data storage means 314. In a presently preferred embodiment, the computer system 300 includes a cloud-based server 310 hosting the application. The server 310 includes the processor 312 and provides segments 332 of the application program to a remote client 320 over the internet 302 to the participant. The application program segments 332 are displayed on the display 10 of the remote client 320, and optionally stored in local storage 314a. The participant enters text and optionally additional data such as photographs in jpg or pdf format in the application program segments 332 using input means 322 such as a real or virtual keyboard or a voice-to-text application. The text 334 and optional additional data entered by the participant, and commands to control the application program, are respectively transmitted back to the server 310, to be stored by the server 310 in data storage 314, and employed by the server 310 to control the execution of the application program. The remote client 320 can be a desk top computer, a lap top computer, a tablet computer, a smart phone, or any other device for displaying the program segments received from the server 310. Preferably, local storage for the text and other data entered by the participant is provided on the remote client 320

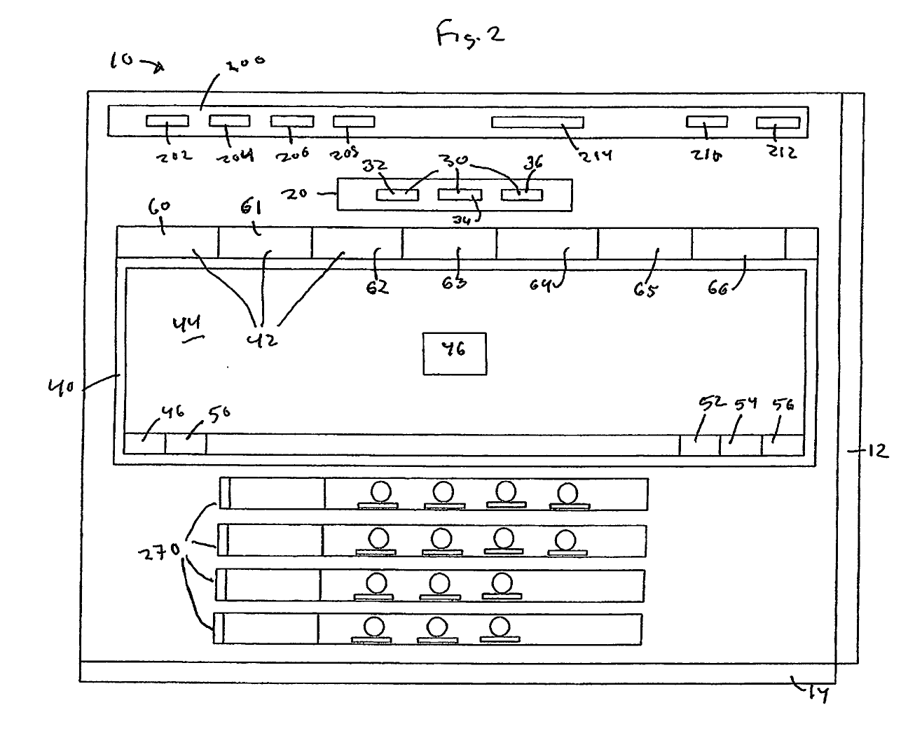

FIG. 2 is a schematic view of a display 10 showing a first screen shot created by a presently preferred embodiment of the application of the present invention. The application program provides on the display 10 with vertical and horizontal control bars 12, 14 and a first control ribbon 20 including a plurality of controls 30 permitting the participant to control the application program. The plurality of controls 30 includes a dashboard control 32 for displaying a dashboard 40 for accessing and displaying a plurality of instructional videos 42 in a video display window 44. Each of the videos 42 is directed to an explanation of a corresponding drafting step in the process for developing a college admissions essay. The dashboard 40 includes instructional video controls 60 (“Welcome message”), 61 (“Step 1”), 62 (“Step 2”), 63 (“Step 3a”), 64 (“Step 3b”), 65 (“Step 3c”), 66 (“Step 4”), for selecting a respective instructional video. The video display window 44 includes a start control 46 for starting a video selected using one of the instructional video controls 60, as well as a volume control 48, a settings control 50 for setting the speed and quality of the video being shown, and a full screen control 52 for toggling back and forth between a full screen presentation of the video (not shown) and the presentation in the video display window 44, as well as a elapsed time control 54 showing the elapsed time the video being presented has been shown.

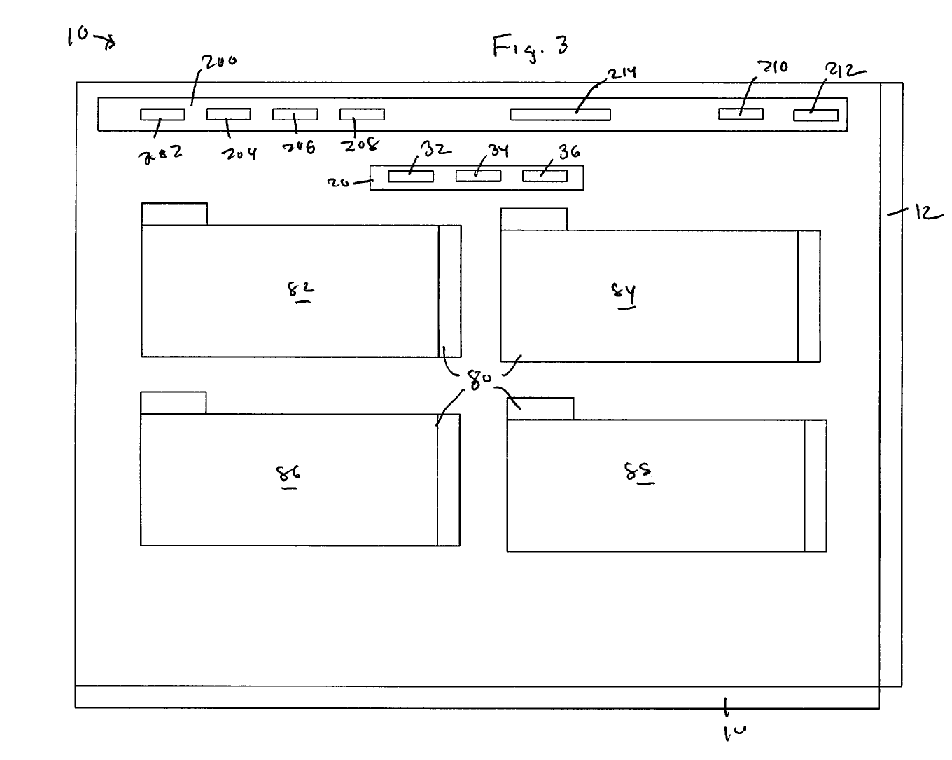

When the first instruction video control 60 is activated by the participant, the first instructional video is downloaded from the server 310 to the client 320, and the participant can start the video using the start control 46. The first instructional video provides an overview of the interactive method of the present invention. At the conclusion of the first instructional video, the participant is directed to start the second instructional video. The second instructional video explains step 1 in the method of the present invention, “Finding Your Story,” which includes an explanation of the elements of every well constructed story, and introduces a four sentence format for outlining a story, (1) initial plan, (2) anticipated outcome, (3) setback and (4) discovery, and directs the participant to a first sentence drafting control 34 (“Four Sentences”) provided on the first control ribbon 20. When the participant activates or selects the first sentence drafting control 34 displays on the displays a plurality of text input windows 80, as shown in FIG. 3. The participant then enters text, such as a single sentence, in each of the text input windows, including the first text input window 82 (“Initial Plan”), the second text input window 84 (“Anticipated Outcome”), the third text input window 86 (“Setback”), and the fourth text input window (“Discovery”). The second instructional video directs the participant to proceed to the third instruction video (“Step 2”) after the participant has entered text in each of the text input windows 80, 82, 84, 86.

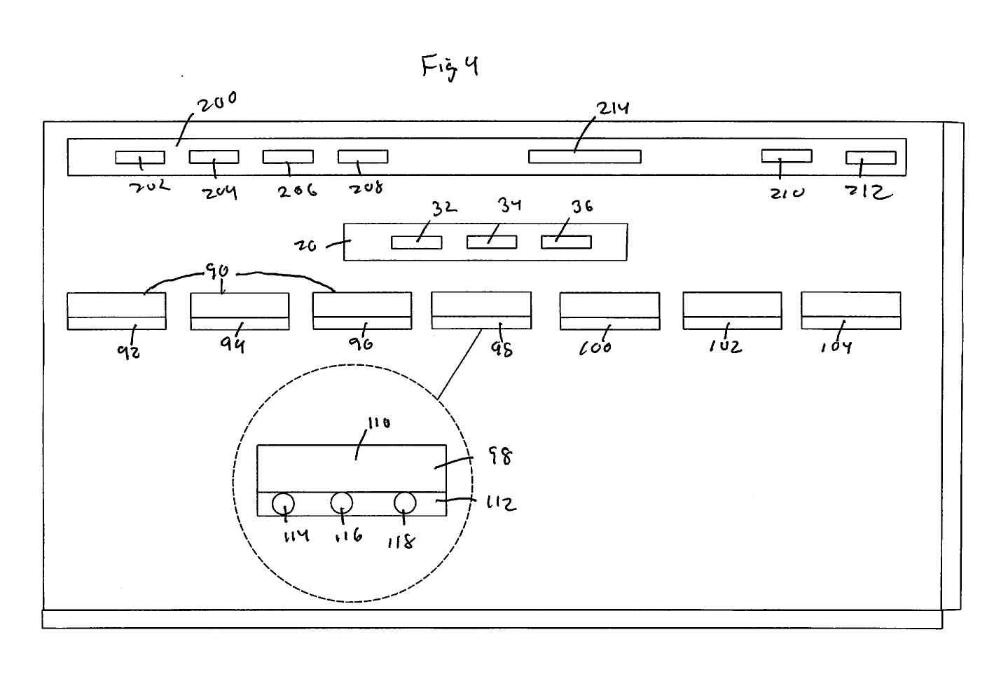

A second sentence drafting control (“Essay”) 36, is presented on the first control ribbon 20. As shown in the schematic view of FIG. 4, the second sentence drafting control 36 when activated or selected provides a plurality of title bubbles 90 on the display for the participant, the title bubbles being arranged in a predefined order, and preferably displaying as titles “Initial Plan” 92, “Anticipated Outcome” 94, “Primary Motivation” 96, “Pivot/Setback” 98, “Discovery” 100, “Magic Link” 102, and “Life Lesson” 104, corresponding to the drafting steps in the present method for developing a college admissions essay. As shown in the expanded insert in FIG. 4, wherein each title bubble, such as, for example, the fourth title bubble 98, includes a title text field 110 and an actions control field 112, the actions control field 112 including at least a related note control 116 for creating a related note bubble. Preferably, each title bubble, such as the fourth title bubble 98, also includes a help control 114 for displaying a help window (not shown) with instructional text specific to each title bubble. Preferably, each title bubble, such as the fourth control bubble 98, also includes a new title bubble control 118 for or generating a new title bubble (not shown).

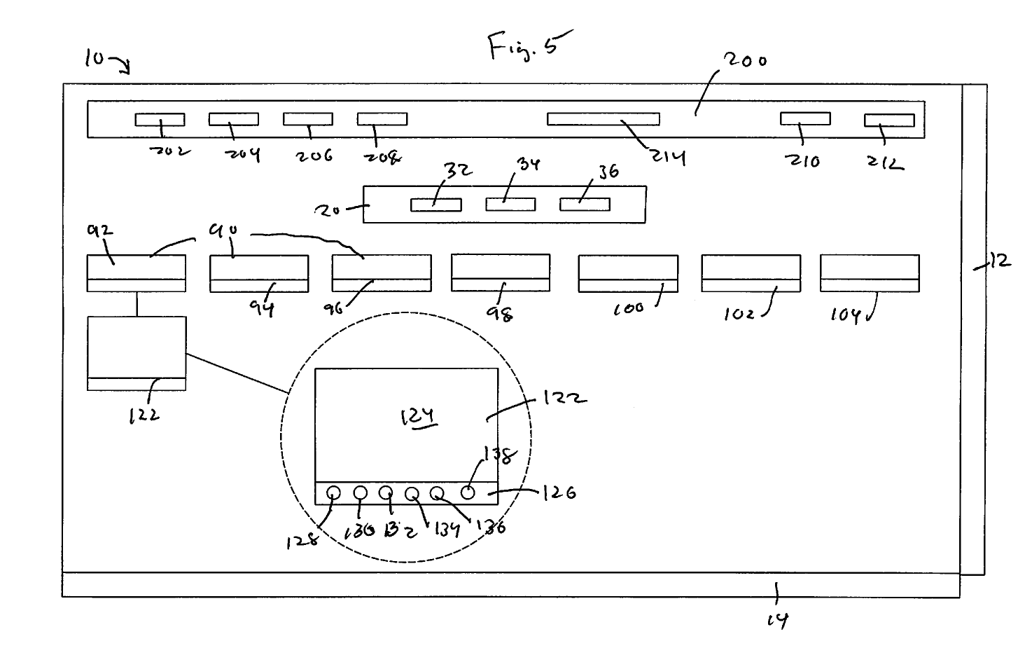

In the instructional video of Step 2, the participant is directed to open note bubbles under each of the four title bubbles corresponding to the four sentences the participant has already entered in the prior step. “Opening” or activating a note bubble requires the participant to click on the related note control 116, to generate a related note bubble such as illustrated in FIG. 5.

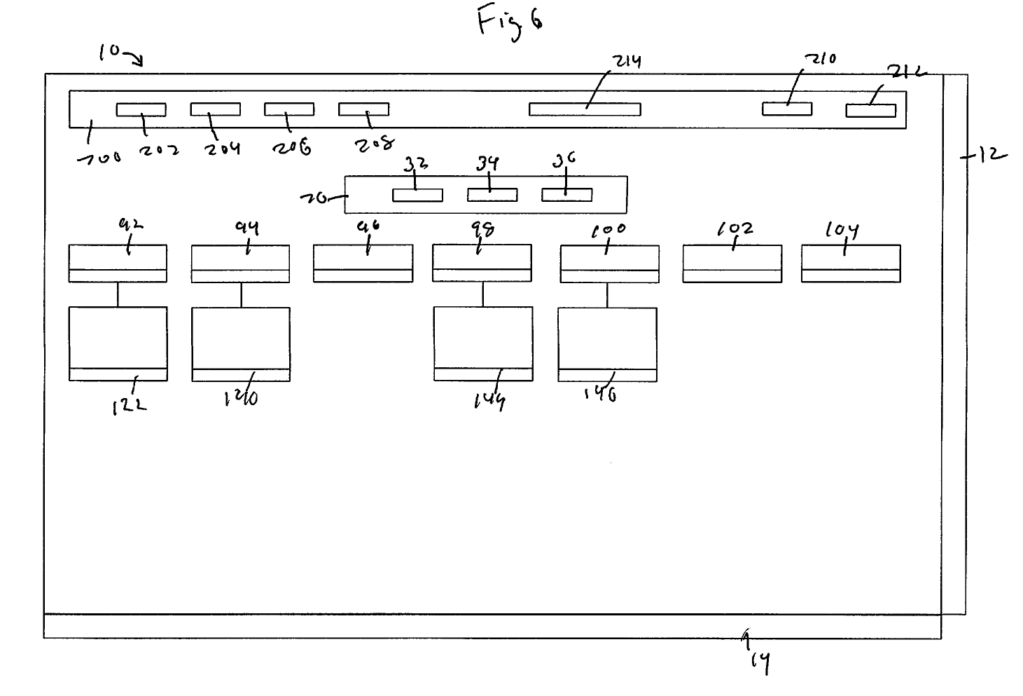

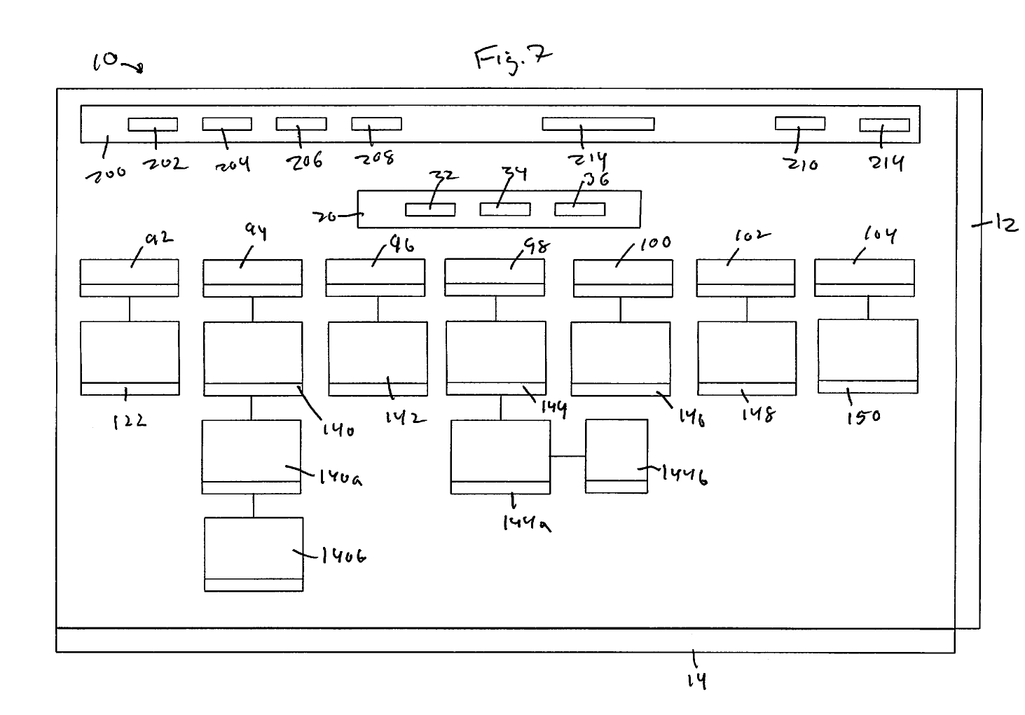

As shown in the enlarged inset in FIG. 5, each note bubble, such as the first note bubble 122, includes a text field 124 in which the participant can insert text, and an actions control field 126 on which a plurality of controls are displayed including a delete control 128 for deleting the bubble 122, a history control 130 for displaying in a new window (not shown) the history of text entered into the note bubble 126, an add new note control 132 for adding a new note bubble related to the note bubble 122 (shown in FIG. 7), an add attachment control 134 for adding an attachment (not shown) such as a graphic file, for example, a photograph of the participant, to the note bubble 122, an add subnote control 136 for adding a subnote to the note bubble 122 (shown in FIG. 6), and a word count control 138 reflecting the number of words entered in the text field 124 of the note bubble 122.

As the participant creates note bubbles 122, 140, 144, 146 corresponding to each of the four sentences entered in Step 1 (FIG. 6), the respective note bubbles 122, 140, 144, 146 are then populated with the text previously entered by the participant. The participant can then amplify on the previously entered text with additional text, such as an additional two or three sentences.

The participant can then proceed to Step 3, which is broken down into three substeps 3a, 3b, and 3c. For each substep, the participant can view a corresponding instructional video 63, 64, 65 for drafting text to be entered in note bubbles corresponding to the three remaining title bubbles 90, 102, 104. For each of the topics reflected by the title bubbles 90, 102, 104, the participant can create new related note bubbles 140a, 140b, 144a and/or new subnote bubbles 144b in which additional text can be entered, as shown in FIG. 7.

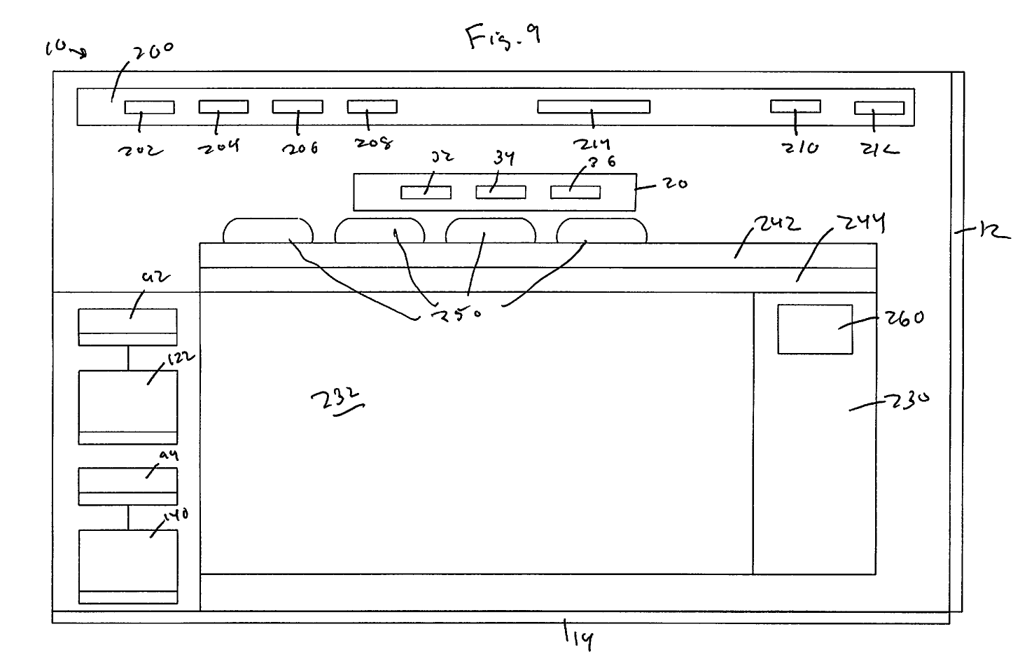

The participant can then proceed to Step 4. A second control ribbon 200 is provided on the display 10, including a “File” menu or tab control 202 for accessing conventional file related commands such as “open,” “close,” “save,” “clone,” “rename,” “restore,” “local backup,” “local restore,” “logout,” “about” and the like; a “Print” menu or tab control 204 for accessing conventional print related commands such as “export as pdf,” “export as HTML,” “export as text,” “export as PNG,” “print outline,” and the like; a “Save” command or tab control 208, a “Share” control 210 for opening a window (not shown) for entering the the name and email address of another individual such as a teacher and sending a draft of the essay to the individual, and an “Essay” control 206 for opening a menu 218 (FIG. 8) of text related controls or commands. The second control ribbon 200 also includes a counter control 212 for displaying the last time the text entered by the participant was saved, and a title control 214 reflected the title given to the essay by the participant.

An option provided by essay menu 216 (FIG. 8) generated by the “Essay” control 206 is a command (“Create First Draft”) 218 to open a text processor 230 including a window 232, merge the text previously entered in the input windows and note bubbles in the predefined order provided by the title bubbles, and display the merged text into a document or first draft of the essay in the text processor window 232 (FIG. 9). The text processor is provided with a conventional action control ribbon 242 including commands (e.g. “File,” “Edit,” “Insert,” “View,” “Format,” “Table”) as well as a conventional format control ribbon 244 including commands for controlling the typeface, type size, justification of the text, etc. Multiple versions of the draft essay are accessible by selecting one of a plurality of tabs 250. The note bubbles 92, 94 etc. and subnote bubbles in which the participant initially entered text also appear on the display 10. A scroll bar 12 is provided to permit the participant to view all the note bubbles.

The essay menu 216 also includes a control 220 for creating a second draft of the text by reproducing the text appearing in the text processor window 232 created by the text merge control 218 as later modified or edited by the participant, as well as a control 222 for creating a final draft of the text appearing in the text processor window 232 created by the second draft control 220 as subsequently modified or edited by the participant. Multiple versions of each of the first, second and final drafts and new documents can be created and viewed using the tabs 250. The essay menu 216 also includes a control 224 for deleting the text essay and a control for renaming the essay 226. A comment control 260 is provided so that the participant or third parties can add comments to the text prepared by the participant and shared with a third party.

As depicted in FIG. 2, the participant's progress in completing each of the steps in the method is shown on a progress control 270. As the participant complete each portion of each of the four steps defined by the method of the present invention, indicia of the participant's completion appears on the progress control 270.

Various modifications can be made in the details of the various embodiments of the articles of the present invention, all within the scope and spirit of the invention and defined by the appended claims.

1. A method for producing a college admission essay carried out by a participant using a computer system and at least one application program, the computer system including a display, at least one processor, input means, a data storage means, the method comprising:
a) providing on the display a first control ribbon including a plurality of controls permitting the participant to control the application program, the plurality of controls including a dashboard control for accessing a plurality of instructional videos, each video being directed to an explanation of a corresponding drafting step in the process for developing a college admissions essay;
b) providing on the first control ribbon a first sentence drafting control, the first sentence drafting control when selected displaying on the display a plurality of text input windows, or a first plurality of title bubbles that allow the participant to display the plurality of text input windows, the participant entering text in the text input windows;
c) presenting on the first control ribbon a second sentence drafting control, the second sentence drafting control when selected providing a plurality of title bubbles on the display for the participant, the title bubbles being arranged in a predefined order corresponding to the drafting steps in the process for developing a college admissions essay;
d) the participant activating at least one of the title bubbles to provide a note bubble, the note bubble related to the corresponding title bubble, the participant entering text in the note bubble,
e) including the text previously entered by the participant in the text input windows in the at least one of the note bubbles;
f) providing on the display a second control ribbon, the second control ribbon including a control for a menu of text controls relating to the text entered by the participant, the menu of text controls including at least a text merge control for merging the text entered by the participant under each title bubble in the predefined order provided by the title bubbles provided by the second sentence drafting control into a document.

2. A method according to claim 1 wherein the plurality of instructional videos includes a first instructional video, the first instructional video providing instruction for entering text in the plurality of text input windows.

3. A method according to claim 1 wherein the text entered in the plurality of text windows populates a corresponding plurality of note bubbles.

4. A method according to claim 1 wherein the plurality of instructional videos includes at least one video providing instruction for entering text in at least one note bubble.

5. A method according to claim 1 wherein the text merge control opens an initial text processor window and displays the merged text in the text processor as a draft of the college application essay for further development by the participant.

6. A method according to claim 1 wherein the menu of text controls includes a control for duplicating the text in initial text processor window in a successive text processor window.

7. A method according to claim 1 wherein each title bubble in includes a text field displaying the title of the bubble and an actions field, the actions field including at least a control for creating a related note bubble.

8. A method according to claim 1 wherein each note bubble includes a text field in which the participant can enter text and an actions field including controls.

9. A method according to claim 7 wherein each title bubble includes a help control for displaying a help window with instructional text specific to each title bubble.

10. A method according to claim 7 wherein each title bubble includes a new title bubble control for generating a new title bubble.

11. A method according to claim 8 wherein the actions field of each note bubble includes a history display control for displaying a history window showing the history of text entered into the note bubble.

12. A method according to claim 8 wherein the actions field of each note bubble includes a new note bubble control for generating a new note bubble linked to the note bubble.

13. A method according to claim 8 wherein the actions field of each note bubble includes a subnote bubble control for generating a subnote bubble linked to the note bubble, the subnote bubble including a field for entering text and a control for displaying the history of text entered into the subnote bubble text field.

14. A method according to claim 13, wherein the text merge control merges of the plurality of all the text in each note bubble, linked note bubble, and linked subnote bubble under each title bubble into the text processor window in the predefined order.

15. A method according to claim 8 wherein the actions field includes an attachments control for adding a preexisting file to the document.

16. A method according to claim 1 wherein the application program is hosted on a cloud-based server and provided to the participant on an internet-enabled access device.

17. A method according to claim 1 further including a progress window for displaying to the participant the participant's completion of the drafting steps.

18. A method according to claim 1 further including a share control for generating a share window for entering information to identify other individuals with whom the participant desires to share the extent of the participant's text entered using the method and a control for sharing the text.

19. A method according to claim 17 the share control further including a comments control for permitting the other individuals to comment on the shared text.
